(19) United States
(12) Patent Application Publication
(10) Pub. No.: US 2021/0070663 A1
(43) Pub. Date: Mar. 11, 2021

(54) INFILTRATION SYSTEM FOR A CMC MATRIX

(71) Applicant: Rolls-Royce High Temperature Composites Inc., Cypress, CA (US)

(72) Inventors: Pathikumar Sellappan, Seal Beach, CA (US); Sungbo Shim, Irvine, CA (US)

(73) Assignee: Rolls-Royce High Temperature Composites Inc., Cypress, CA (US)

(21) Appl. No.: 17/012,952

(22) Filed: Sep. 4, 2020

Related U.S. Application Data
(60) Provisional application No. 62/896,918, filed on Sep. 6, 2019.

(51) Int. Cl. C04B 35/80; C04B 35/628; C04B 35/657

(52) U.S. Cl. CPC C04B 35/80; C04B 35/62892; C04B 35/62863; C04B 35/62873; C04B 35/657; C04B 2235/616; C04B 2235/425; C04B 2235/427; C04B 2235/424; C04B 2235/428; C04B 2235/5252; C04B 2235/3826

(57) ABSTRACT

A system of infiltration for producing a ceramic matrix composite (CMC) is provided in which a slurry is applied to an outer surface of a porous preform. The porous preform includes a framework of ceramic fibers. The slurry may include a solvent and a particulate. The porous preform may be infiltrated with the slurry. The particulate in the slurry may include a plurality of coarse particles and a plurality of fine particles. The coarse particles may have a d50 factor of 10-20 microns. The fine particles may have a d50 factor of 0.5-3 microns. A ratio of coarse particles to fine particles in the slurry may be between 1.5:1 and 4:1, inclusively.

### CROSS-REFERENCE TO RELATED APPLICATION

This application claims the benefit of U.S. Provisional Application No. 62/896,918, filed Sep. 6, 2019. The contents of U.S. Provisional Application No. 62/896,918 are hereby incorporated by reference in their entirety.

### TECHNICAL FIELD

The present disclosure is directed generally to the fabrication of ceramic matrix composites and more particularly to a method to improve the infiltration of a porous preform.

### BACKGROUND

Ceramic matrix composites (CMCs), which include ceramic fibers embedded in a ceramic matrix, exhibit a combination of properties that make them promising candidates for industrial applications that demand excellent thermal and mechanical properties along with low weight, such as gas turbine engine components. Accordingly, there is a need for inventive systems and methods including CMC materials described herein.

### BRIEF DESCRIPTION OF THE DRAWINGS

The embodiments may be better understood with reference to the following drawings and description. The components in the figures are not necessarily to scale. Moreover, in the figures, like-referenced numerals designate corresponding parts throughout the different views.

FIG. 1 illustrates a cross-sectional view of a CMC that was prepared with a low solid loading slurry;

FIG. 2 illustrates a cross-sectional view of a CMC that was prepared with a high solid loading slurry; and

FIG. 3 is a flow chart of an exemplary method of infiltrating a preform.

### DETAILED DESCRIPTION

The system may be used in an example of a method of infiltration for producing a ceramic matrix composite (CMC) in which a slurry is applied to an outer surface of a porous preform. The porous preform includes a framework of ceramic fibers. The slurry includes a solvent and a particulate. The porous preform is infiltrated with the slurry. The particulate in the slurry includes a plurality of coarse particles and a plurality of fine particles. The coarse particles have a d50 factor of 10-20 microns. The fine particles have a d50 factor of 0.5-3 microns. A ratio of coarse particles to fine particles in the slurry is between 1.5:1 and 4:1, inclusively.

Another example of a method of producing a ceramic matrix composite (CMC) is provided in which a slurry is applied to an outer surface of a porous preform. The slurry includes a solvent and a particulate. The particulate makes up at least 70% of the slurry by volume. The porous preform is infiltrated with the slurry. The porous preform is dried after infiltration with the slurry. The dried porous preform forms a ceramic matrix composite.

Current ceramic matrix composites (CMC) may include a significant amount of residual silicon. Furthermore, if a solid loading of a slurry used to produce the CMC is relatively low, defects, such as mudcracks may develop in the CMC. The defects may be a failure initiation site during loading of the CMC, which may reduce the strength of the CMC. One interesting feature of the systems and methods described below may be that a solid loading, a viscosity, and/or a pH of a slurry for infiltration of a porous preform may be manipulated, such that defects such as mudcracks and/or unreacted silicon in a final CMC component produced are minimized.

A method for producing a CMC component may begin with the fabrication of a two-dimensional or three-dimensional inorganic fiber preform, which forms a structural scaffold for subsequent infiltration of a ceramic matrix. To create the inorganic fiber preform, chopped fibers, continuous fibers, woven fabrics or combinations thereof are laid up, fixed and shaped into the configuration of a desired component, for example, a component of a gas turbine engine. The fibers in the inorganic fiber preform may be made from an inorganic material that is stable at processing temperatures above about 1000 degrees Celsius and is compatible with the temperature of a molten alloy infiltrant. Suitable examples include, but are not limited to, aluminum oxide (Al₂O₃), mullite (Al₆Si₂O₁₃), zirconium oxide (ZrO₂), carbon (C), graphite, silicon carbide (SiC), silicon carbon nitride, silicon nitride, and mixtures and combinations thereof.

The inorganic fiber preform, or porous preform, may be infiltrated and partially rigidized/densified via an additive process such as chemical vapor infiltration (CVI) to create a low strength, compliant fiber interface coating to promote matrix deflection, such as crack deflection. In the example of the additive process being CVI, about 40%-60% porosity remains in the porous preform prior to initiating the systems and methods described herein. Once the porous preform is shaped and partially rigidized/densified, a matrix material may be infiltrated into the porous preform. This infiltration process may include applying a slurry to the porous preform.

The slurry may be a composition that includes a solvent and a particulate suspended in the solvent. The slurry may have a viscosity in a range of 200-800 centipoise (cP). In some examples, the slurry additionally includes a pre-gellant material. The slurry may also include optional gelation initiators, promotors, and/or other additives. As the slurry flows into the interstices between the inorganic fibers of the partially densified preform, the particles in the slurry impregnate the pores and/or capillaries of the preform and are positioned in the interstices between the fibers of the preform.

The particulate may be particles of ceramic material suspended in the solvent. In some examples the particulate may include aluminum nitride, aluminum diboride, boron carbide, aluminum oxide, mullite, zirconium oxide, carbon, silicon carbide, silicon nitride, transition metal nitrides, transition metal borides, rare earth oxides, and mixtures and combinations thereof. Examples of the particulate may further include carbon sources such as graphite, diamond, carbon black, and combinations thereof.

The solvent in which the particulate is suspended may be an aqueous and/or organic solvent, such as water. In some examples, the solvent is water only. In other examples, the solvent includes water and other components. Other solvents and/or components that may be used in the slurry include, but are not limited to alcohols, ethanol, methanol isopropyl alcohol, methyl ethyl ketone, or toluene. The solvent may be selected to disperse or dissolve the pre-gellant material and any other slurry additives, such as a gellation initiator.

The slurry may have a predetermined solid loading volume percentage (vol %). The vol % is indicative of a percentage of the volume of the slurry that is the particulate. For example, the slurry may be prepared at about 70 vol % solid loading, which means that about 70% of the slurry is the particulate and about 30 vol % of the slurry is the solvent or other additives. In some examples, the vol % solid loading of the slurry may be greater than or equal to about 70 vol %. The vol % solid loading may vary by up to +/−2%, and therefore “about,” as used herein refers to +/−2% unless noted otherwise.

In one example, the slurry may further be described as a high volumetric solid loading slurry or high solid loading slurry. If the slurry is a high solid loading slurry, it includes at least 55% particulate solids by volume (55 vol % solid loading), whereas a low solid loading slurry includes less than 55% particulate solids. In another example, the slurry may include at least 70% particulate solids by volume. The higher the solid loading of the slurry, the more potential particulate may infiltrate the partially densified and/or rigidized preform. Obtaining a high solid loading may be advantageous in reducing defects, such as mudcrack formation during the drying of the slurry. Mudcracks include cracks or splits in the dried, slurry-infiltrated preform, and other defects resulting from, for example, insufficient particulate in the slurry.

Furthermore, the use of low solid loading slurries and/or slurries having particles with relatively large diameters, for example particles that have a d50 factor greater than 30 μm, may result in an infiltrated CMC component with defects of high residual porosity. Particles having larger diameters may be unable to infiltrate pores, capillaries, and/or channels having relatively small diameters. If a slurry has a low solid loading, the slurry may not have sufficient particulate to fill the capillaries, channels, and/or pores of the preform. The resulting structure may have unfilled regions or cavities that require subsequent filling, otherwise known as residual porosity. Material used to fill the residual porosity, for example, silicon or a preceramic polymer, may not be as strong or desirable as the particulate material of the slurry described herein. As a result, slurry infiltrated preforms having higher residual porosity may result in weaker, less desirable finished CMC components.

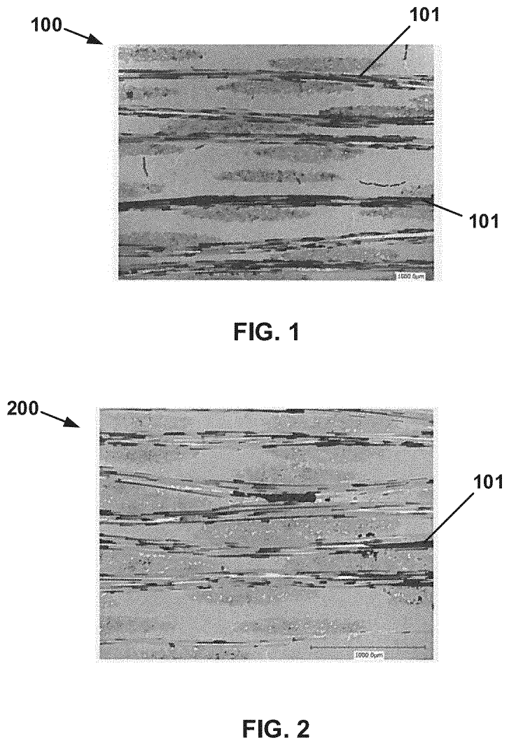

FIG. 1 illustrates an example of a first CMC 100, which was prepared with a low solid loading slurry. As shown in FIG. 1, the first CMC 100 has multiple defects in the form of mudcracks 101. FIG. 2 illustrates an example of a CMC, which was prepared with a high solid loading slurry provided by the system described herein. By comparison, the CMC shown in FIG. 2 has fewer defects in the form of mudcracks 101 than the CMC shown in FIG. 1. Additionally, the mudcracks 101 in the CMC shown in FIG. 2 are relatively thinner and less frequent than the mudcracks 101 shown in FIG. 1.

In some examples, the system performing the slurry infiltration may include vacuum infiltration, which includes introducing a slurry formulation to a porous fiber preform in a vacuum chamber and adjusting a pressure of the chamber to a predetermined pressure to promote infiltration. Slurry infiltration may occur through surfaces of the preform exposed to the slurry formulation. Other examples of slurry infiltration may include slip casting, which includes introducing the slurry into a mold where the preform is positioned.

During the infiltration of the porous preform, a slurry may be included that has particles with more than one effective diameter as measured by their D50 factor. For example, the slurry may include a coarse particle set and a fine particle set. The coarse particle set may be a set of particles in the slurry with d50 of 10-20 μm. The fine particle set may be a set of particles in the slurry with d50 of 0.5-3 μm. The coarse particle set may allow for high solid loading slurries to be fabricated due to the high solid fraction to the low surface area. The fine particle set may be configured to fill the smaller remaining interstices of the preform and refine the matrix grain structure. The particles in the fine particle set may be limited in their solid loading due to their high surface area to solid fraction. Combining multiple particle size distributions can allow higher solid fractions to be obtained along with a refinement of the remaining interstitial voids. In one example, a ratio of coarse particles (d50 of 10-20 μm) to fine particles (d50 of 0.5-3 μm) in the slurry may be between 1.5:1 and 4:1, inclusively.

In addition to the particles in the slurry having varying sizes, the particles may have varying shapes. In some examples, the particles may have a wide variety of regular or irregular shapes including, for example, spheres, rods, disks, and any other shapes suitable for infiltration of the preform. The major dimensions of the particles may form a monomodal, a bimodal, or a multimodal distribution. In some examples, the particles are generally sphere shaped, and the diameters of the particles make up a multimodal distribution to more effectively flow within the fibers of the preform and pack more densely within the pores or other voids of the preform. In some examples, the particles might have sharp edges stemming from grinding process during the initial powder synthesis stage. The shape of the particles in the slurry may have an effect on the viscosity in the slurry.

The slurry may further be described as a high volumetric solid loading or high solid loading slurry. Solid loading is an amount of suspended solids or particulate in a liquid and/or solvent, such as water. The higher the solid loading of the slurry, the more potential particulate may infiltrate the partially densified and/or rigidized preform. In one example, a slurry having “high solid loading” refers to a slurry that includes at least 55% particulate solids by volume. In another example, the slurry including at least 70% particulate solids by volume refers to “high solid loading.”

The use of low solid loading slurries and/or slurries having particles with relatively large diameters may result in an infiltrated CMC component with defects such as high residual porosity. Particles having larger diameters may be unable to infiltrate pores, capillaries, and/or channels having relatively small diameters. Furthermore, if a slurry has a low solid loading, the slurry may not have sufficient particulate to fill the capillaries, channels, and/or pores of the preform. The resulting structure may have defects such as residual porosity in the form of gaps or cavities that require subsequent filling. Material used to fill the residual porosity, for example, silicon or a preceramic polymer, may not be as strong or desirable as the particulate material of the slurry, which may include, for example, silicon carbide. Slurry infiltrated preforms having higher residual porosity may result in weaker, less desirable finished CMC components. Thus, an issue addressed by the systems and methods described herein is high residual porosity.

As a solid loading of a given slurry is increased, the viscosity of the slurry may also increase. As a result, infiltration of high solid loading slurries into the preform may be difficult if the viscosity is sufficiently high, such that the slurry cannot infiltrate the preform. A predetermined viscosity of the slurry may be maintained, such that the slurry has a solid loading that is as high as possible with a viscosity that allows for infiltration of the preform. In some examples, the predetermined viscosity of the slurry may be between 200-800 cP, inclusively.

The viscosity of the slurry may depend on several factors, such as solid loading, particle shape, coarse to fine particle ratio, and pH. For example, if particles in the particulate of the slurry have a substantially spherical shape, the viscosity of the slurry may be lower than viscosity of slurry having more angular particles. The pH of the slurry may depend on several factors, such as the type of powder and dispersant used in the slurry. Alternatively or in addition, if a pH of the slurry is maintained in a range of 9-12, inclusively, the particles in the slurry may be homogenously dispersed due to electrosteric stabilization. However, if the pH of the slurry falls out of the 9-12 range, the particles may become less homogenously dispersed, causing the slurry to become undesirably viscous and inhomogeneous. Furthermore, the pH may be adjusted to of the zeta potential of the slurry. The zeta potential is an electrokinetic potential of a colloidal system, such as the slurry, which affects the dispersion and stability of the slurry. A zeta potential value that is greater than +30 mV and less than −30 mV may have sufficient repulsive force in SiC particles to attain desirable stability of the slurry. Thus the pH may be modified, such that a zeta potential value of the slurry is greater than +30 mV and less than −30 mV.

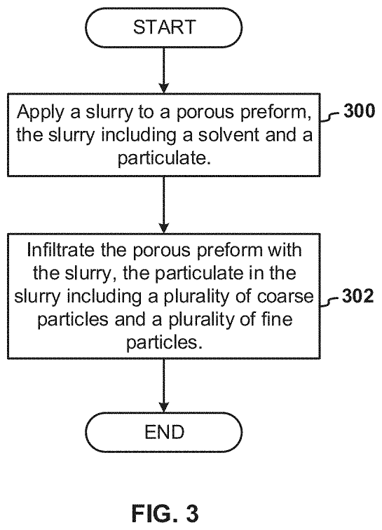

FIG. 3 illustrates a flow diagram of an example of steps to produce a CMC component having less than 10% silicon by volume. A slurry is applied to an outer surface of the porous preform (300). The porous preform comprises a framework of ceramic fibers. The porous preform is infiltrated with the slurry (302). The particulate comprises a plurality of coarse particles and a plurality of fine particles. The coarse particles have a d50 factor of 10-20 microns. The fine particles have a d50 factor of 0.5-3 microns. A ratio of coarse particles to fine particles in the slurry is between 1.5:1 and 4:1, inclusively. The ratio of coarse to fine particles may affect the slurry viscosity, the quality of the infiltration, and the packing density. The steps may include additional, different, or fewer operations than illustrated in FIG. 3. The steps may be executed in a different order than illustrated in FIG. 3.

For example, the method of fabrication of the CMC may include other steps, such as laying up of plies to form a fiber preform having a predetermined shape, and/or application of a fiber interphase coating such as boron nitride to the fiber preform prior to rigidization. A rigidized fiber preform may be formed by applying a matrix material to the fiber preform during a chemical vapor infiltration (CVI) process. The rigidized fiber preform may be infiltrated with a slurry comprising silicon carbide particles in a liquid carrier into the SiC fiber preform.

After slurry infiltration, the slurry may be dried to remove the solvent. At this stage, the dried preform may be considered a ceramic matrix composite. A complete CMC component may be formed by melt infiltration of a molten material, such as silicon, after slurry infiltration of the preform. Because the porous preform has sufficient low residual porosity after slurry infiltration as described herein, the complete CMC may include 5-15% residual silicon by volume after melt infiltration. In other examples, the complete CMC component may include less than 10% residual silicon by volume. The complete CMC component may have less than 5% residual porosity.

The slurry may further include reactive elements such as carbon that can react with the molten silicon or silicon alloy during melt infiltration, thereby reducing free silicon in the bulk of the CMC component.

### Example

A slurry including a solid-loading of 63.5% is applied to an outer surface of a porous preform. The slurry includes a set of coarse particles and a set of fine particles. The coarse particles have a D50 of approximately 11.5 um. The fine particles have a D50 of approximately 0.9 um. The ratio of coarse particles to fine particles is approximately 2.5. A pH of the slurry before infiltration is approximately 9.5. The porous preform is infiltrated with the slurry. After subsequent melt infiltration with silicon and/or a silicon alloy, the residual silicon is approximately 7-10 vol %. The values provided in this example may vary by +/−10%, therefore, “approximately,” as used herein refers to +/−10% unless noted otherwise.

To clarify the use of and to hereby provide notice to the public, the phrases “at least one of <A>, <B>, . . . and <N>” or “at least one of <A>, <B>, <N>, or combinations thereof” or “<A>, <B>, . . . and/or <N>” are defined by the Applicant in the broadest sense, superseding any other implied definitions hereinbefore or hereinafter unless expressly asserted by the Applicant to the contrary, to mean one or more elements selected from the group comprising A, B, . . . and N. In other words, the phrases mean any combination of one or more of the elements A, B, . . . or N including any one element alone or the one element in combination with one or more of the other elements which may also include, in combination, additional elements not listed. Unless otherwise indicated or the context suggests otherwise, as used herein, “a” or “an” means “at least one” or “one or more.”

While various embodiments have been described, it will be apparent to those of ordinary skill in the art that many more embodiments and implementations are possible. Accordingly, the embodiments described herein are examples, not the only possible embodiments and implementations.

The subject-matter of the disclosure may also relate, among others, to the following aspects:

A first aspect relates to a method of infiltration for producing a ceramic matrix composite (CMC), the method comprising: applying a slurry to an outer surface of a porous preform comprising a framework of ceramic fibers, the slurry comprising a solvent and a particulate; and infiltrating the porous preform with slurry, wherein the particulate in the slurry comprises a plurality of coarse particles and a plurality of fine particles, wherein the coarse particles have a d50 factor of 10-20 microns, wherein the fine particles have a d50 factor of 0.5-3 microns, and wherein a ratio of coarse particles to fine particles in the slurry is between 1.5:1 and 4:1, inclusively.

A second aspect relates to the method of the first aspect, wherein a pH of the slurry is between 9 and 12, inclusively.

A third aspect relates to the method of any preceding aspect, wherein the particulate comprises at least 55% of the slurry by volume.

A fourth aspect relates to the method of any preceding aspect, wherein the particulate comprises at least 70% of the slurry by volume.

A fifth aspect relates to the method of any preceding aspect, wherein the particulate includes silicon carbide.

A sixth aspect relates to the method of any preceding aspect, wherein the solvent includes water and organic solvents.

A seventh aspect relates to the method of any preceding aspect, wherein the porous preform is in a shape of a component for a gas turbine engine.

An eighth aspect relates to the method of any preceding aspect, further comprising positioning the porous preform in a vacuum chamber; covering at least a portion of porous preform with the slurry; and increasing a pressure in the vacuum chamber to urge the slurry into the porous preform.

A ninth aspect relates to a method for producing a ceramic matrix composite (CMC), the method comprising: applying a slurry to an outer surface of a porous preform, the slurry comprising a solvent and a particulate, wherein the particulate makes up at least 70% of the slurry by volume; infiltrating the porous preform with the slurry; and drying the porous preform after infiltrating with the slurry to form the ceramic matrix composite.

A tenth aspect relates to the method of any preceding aspect, wherein the particulate in the slurry comprises a plurality of coarse particles and a plurality of fine particles, wherein the coarse particles have a d50 factor of 10-20 microns, wherein the fine particles have a d50 factor of 0.5-3 microns.

An eleventh aspect relates to the method of any preceding aspect, wherein a ratio of coarse particles to fine particles in the slurry is between 1.5:1 and 4:1, inclusively.

A twelfth aspect relates to the method of any preceding aspect, further comprising modifying a pH of the slurry, such that the slurry has a sufficiently low viscosity allowing the slurry to infiltrate the porous preform.

A thirteenth aspect relates to the method of any preceding aspect, wherein a zeta potential of the slurry is either more than +30 mV or less than −30 mV.

A fourteenth aspect relates to the method of any preceding aspect, wherein the infiltrating the porous preform with the slurry includes vacuum infiltration.

A fifteenth aspect relates to the method of any preceding aspect, wherein the slurry includes silicon carbide, graphite, diamond, carbon black, or combinations thereof.

A sixteenth aspect relates to the method of any preceding aspect, further comprising melt infiltrating the ceramic matrix composite with silicon, after the drying the porous preform.

A seventeenth aspect relates to the method of any preceding aspect, wherein the ceramic matrix composite includes between 5-15% silicon by volume.

An eighteenth aspect relates to the method of any preceding aspect, wherein the ceramic matrix composite includes less than 10% silicon by volume.

A nineteenth aspect relates to the method of any preceding aspect, wherein the ceramic matrix composite includes less than 5 vol % residual porosity.

A twentieth aspect relates to the method of any preceding aspect, wherein the slurry has a viscosity between 200-800 cP, inclusively.

In addition to the features mentioned in each of the independent aspects enumerated above, some examples may show, alone or in combination, the optional features mentioned in the dependent aspects and/or as disclosed in the description above and shown in the figures.

What is claimed is:

1. A method of infiltration for producing a ceramic matrix composite (CMC), the method comprising:
applying a slurry to an outer surface of a porous preform comprising a framework of ceramic fibers, the slurry comprising a solvent and a particulate; and
infiltrating the porous preform with slurry, wherein the particulate in the slurry comprises a plurality of coarse particles and a plurality of fine particles, wherein the coarse particles have a d50 factor of 10-20 microns, wherein the fine particles have a d50 factor of 0.5-3 microns, and wherein a ratio of coarse particles to fine particles in the slurry is between 1.5:1 and 4:1, inclusively.

2. The method of claim 1, wherein a pH of the slurry is between 9 and 12, inclusively.

3. The method of claim 1, wherein the particulate comprises at least 55% of the slurry by volume.

4. The method of claim 1, wherein the particulate comprises at least 70% of the slurry by volume.

5. The method of claim 1, wherein the particulate includes silicon carbide.

6. The method of claim 5, wherein the solvent includes water and organic solvents.

7. The method of claim 1, wherein the porous preform is in a shape of a component for a gas turbine engine.

8. The method of claim 1, further comprising positioning the porous preform in a vacuum chamber; covering at least a portion of porous preform with the slurry; and increasing a pressure in the vacuum chamber to urge the slurry into the porous preform.

9. A method for producing a ceramic matrix composite (CMC), the method comprising:
applying a slurry to an outer surface of a porous preform, the slurry comprising a solvent and a particulate, wherein the particulate makes up at least 70% of the slurry by volume;
infiltrating the porous preform with the slurry; and
drying the porous preform after infiltrating with the slurry to form the ceramic matrix composite.

10. The method of claim 9, wherein, the particulate in the slurry comprises a plurality of coarse particles and a plurality of fine particles, wherein the coarse particles have a d50 factor of 10-20 microns, wherein the fine particles have a d50 factor of 0.5-3 microns.

11. The method of claim 10, wherein a ratio of coarse particles to fine particles in the slurry is between 1.5:1 and 4:1, inclusively.

12. The method of claim 9, further comprising modifying a pH of the slurry, such that the slurry has a sufficiently low viscosity allowing the slurry to infiltrate the porous preform.

13. The method of claim 12, wherein a zeta potential of the slurry is more than +30 mV or less than −30 mV.

14. The method of claim 9, wherein the infiltrating the porous preform with the slurry includes vacuum infiltration.

15. The method of claim 14, wherein the slurry includes silicon carbide, graphite, diamond, carbon black, or combinations thereof.

16. The method of claim 9, further comprising melt infiltrating the ceramic matrix composite with silicon, after the drying the porous preform.

17. The method of claim 16, wherein the ceramic matrix composite includes between 5-15% silicon by volume.

18. The method of claim 16, wherein the ceramic matrix composite includes less than 10% silicon by volume.

19. The method of claim 9, wherein the ceramic matrix composite includes less than 5 vol % residual porosity.

20. The method of claim 9, wherein the slurry has a viscosity between 200-800 cP, inclusively.
